(19) United States
(12) Patent Application Publication
(10) Pub. No.: US 2009/0108510 A1
(43) Pub. Date: Apr. 30, 2009

(54) Screw type inerter mechanism

(75) Inventors: Fu-Cheng Wang, Taipei (TW); Mao-Sheng Hsu, Taipei (TW); Wei-Jiun Su, Taipei (TW); Tz-Chain Lin, Taipei (TW)

Correspondence Address: Mr. Peter F. Corless;Mr. Steven M. Jensen, EDWARDS ANGELL PALMER & DODGE LLP, 111 Huntington Avenue, Boston, MA, 02199-7613, US

(73) Assignee: National Taiwan University, Taipei (TW)

(21) Appl. No.: 12/220,821

(22) Filed: Jul. 29, 2008

(30) Foreign Application Priority Data
Oct. 26, 2007 (TW) 096140537

(51) Int. Cl. F16F 15/02; F16F 7/10; F16F 9/16; F16F 15/131

(52) U.S. Cl. 267/75

(57) ABSTRACT

A screw type inerter mechanism includes a screw with a limit portion and a thread portion with threads; a screw cap engaged with the thread portion of the screw; an inertia body fixed to the limit portion of the screw; and a connection body engaged with the limit portion of the screw wherein an axial of the screw serves as a rotation axial for the screw to rotate relatively to the connection body. Thus, when a non-zero external force is applied to the inerter mechanism to generate relative horizontal displacement between the screw cap and the connection body, the screw cap brings the screw to rotate, which further brings the inertia body to rotate, thereby achieving the inerter features.

### BACKGROUND OF THE INVENTION

1. Field of the Invention

The present invention relates generally to an inerter mechanism, and more particularly to a screw type inerter mechanism.

2. Description of Related Art

In recent years, mechanical/electrical system integration has become an important trend. In conventional engineering application, there are two ways for a mechanical network to correspond to an electrical circuit. One is ‘force-current’ analogy, wherein mass, damper and spring correspond to capacitor, resistor and inductor, respectively. The other is ‘force-voltage’ analogy, wherein mass, damper and spring correspond to inductor, resistor and capacitor, respectively.

In a mechanical network, springs and dampers are elements with two terminals. However, acceleration of a mass element is measured relative to the ground. In other words, the reference frame of the conventional mass element is limited by Newton's Second Law. Hence, a mass element fails to be a true two-terminal element since one terminal must always be the inertial frame.

On the other hand, two terminals of resistors, inductors and capacitors are not limited by reference points. Therefore, compared to a conventional mass element, the corresponding electrical element must have one terminal connected to the ground as the reference point, thereby limiting the correspondence between the electrical circuits and the mechanical networks. Referring to J. L. Shearer, A. T. Murphy and H. H. Richardson, “Introduction to System Dynamics”, Addison-Wesley, 1967, Page 111, according to related electrical/mechanical correspondence, electrical circuits have been used for predicting operation modes of mechanical structures in the mechanical engineering field since 1960's. However, the conventional mass element limits the correspondence between electrical circuits and mechanical networks. Therefore, it is a challenge for the academic and the industry to find a two-terminal mechanical element to replace mass.

Accordingly, WO 03/005142 A1 discloses a concept of inerter in which the inerter, spring and damper are two-terminal elements. Therefore, complete correspondence, in which the conventional mass element is substituted by the inerter, between electrical and mechanical networks can be established, Therefore, many concepts of the electrical systems can be directly applied to mechanical systems, such as car suspension systems, vehicle steering control, train suspension systems, building isolation systems and so on.

After the inerter theory was proposed, a gear type inerter mechanism including a gear set and rack was proposed. As shown in FIG. 1, the gear type inerter mechanism includes a base body 10, a rack 11 horizontally disposed on the base body 10, a gear set 12 engaged with the rack 11, and a flywheel 13 connected to the gear set 12.

When a non-zero external force in direction A or B is applied to one end of the rack 11 to generate a relative displacement between the rack 11 and the base body 10, the rack 11 brings the gears 121, 122 of the gear set 12 to rotate, which further brings the flywheel 13 to rotate, thereby converting the linear motion between the rack 11 and the base body 10 to the rotational motion. Meanwhile, the gear type inerter mechanism has two terminals, the rack 11 and the base body 10. Further, the dynamic equation of an inerter is derived as F=b·a, wherein F, a and b represent the applied force, the relative acceleration of two terminals and the inerter coefficient (called inertance) of the mechanism, respectively. The inertance is calculated from the radius and the inertia of the gears, and the inertia of the flywheel. According to the dynamic equation, a suitable gear type inerter mechanism can be obtained by changing sizes of the gears and the flywheel. The gear type inerter mechanism can further overcome the drawback of limited correspondence between electrical circuits and mechanical networks.

Although it is easy to design the gear type inerter mechanism and to obtain materials thereof, the friction force between the gears can be rather large and a serious problem of backlash exists. The backlash means two gears cannot be tightly assembled and accordingly the two gears during operation cannot contact with each other. Therefore, when the rotational direction of gears is changed at high speed, backlash can result in retardant or phase draggle. Also, although backlash can be reduced by adjusting axial distance between the gears, the friction force is increased at the same time.

As an ideal inerter mechanism has no friction force and does not consume system energy, it is urgent how to propose an inerter mechanism that efficiently overcomes large friction force and backlash existing in the prior art.

### SUMMARY OF THE INVENTION

According to the above drawbacks, an objective of the present invention is to provide a screw type inerter mechanism so as to improve correspondence between electrical circuits and mechanical networks.

Another objective of the present invention is to provide a screw type inerter mechanism so as to reduce the friction force and system energy dissipation, and to make the mechanism closer to an ideal inerter.

A further objective of the present invention is to provide a screw type inerter mechanism so as to reduce conventional backlash generated by gear transmission.

In order to attain the above and other objectives, the present invention provides a screw type inerter mechanism including a screw at least having a limit portion and a thread portion with threads; a nut engaged with the thread portion of the screw; an inertia body mounted on the limit portion of the screw; and a connection body engaged with the limit portion of the screw, wherein an axis of the screw serves as a rotation axis for the screw to rotate relatively to the connection body.

In accordance with the present invention, the connection body includes bearings, and the connection body is engaged with a specific position of the limit portion of the screw through the bearings, that is, the screw rotates relatively to the connection body without changing the relative horizontal and vertical positions.

The present mechanism further includes an assisting element connected to the nut and having at least a connection point to connect an external machine. The present mechanism further includes an assisting element connected to the connection body and having at least a connection point to connect an external machine.

According to the screw type inerter mechanism of the present invention, if a non-zero external force is applied to the present system so as to generate relative horizontal displacement between the nut and the connection body, the screw rotates and further causes the inertia body to rotate, thereby achieving inerter features. Furthermore, the backlash between the nut and the screw is not so serious as that in the prior art, and the backlash of the present invention can be eliminated by preloading. Moreover, the contact point between the components of the screw set is formed by bearings, so as to greatly reduce friction force therebetween, and therefore the mechanism of the present invention is much closer to an ideal inerter, thereby improving the correspondence between electrical circuits and mechanical networks.

### BRIEF DESCRIPTION OF DRAWINGS

FIG. 1 is a perspective view of a conventional gear type inerter mechanism;

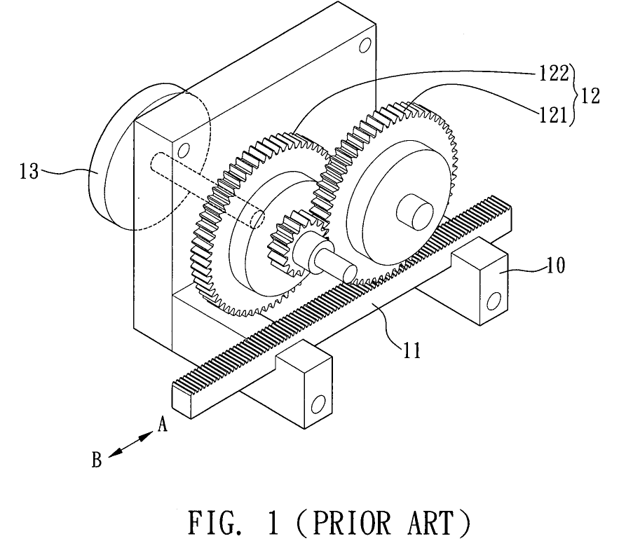

FIG. 2 is an exploded diagram of a screw type inerter mechanism according to the present invention;

FIG. 3 is a sectional diagram of a screw type inerter mechanism according to the first embodiment of the present invention;

FIG. 4 is a sectional diagram of a screw type inerter mechanism according to the second embodiment of the present invention;

FIG. 5 is a sectional diagram of a screw type inerter mechanism according to the third embodiment of the present invention;

FIG. 6 is a partial solid diagram of a screw type inerter mechanism according to the fourth embodiment of the present invention;

FIG. 7 is a partial diagram of a screw type inerter mechanism according to the fifth embodiment of the present invention; and

FIG. 8 is a partial solid diagram of a screw type inerter mechanism according to the sixth embodiment of the present invention.

### DETAILED DESCRIPTION OF PREFERRED EMBODIMENTS

The following illustrative embodiments are provided to illustrate the disclosure of the present invention, these and other advantages and effects can be apparent to those skilled in the art after reading the disclosure of this specification.

### First Embodiment

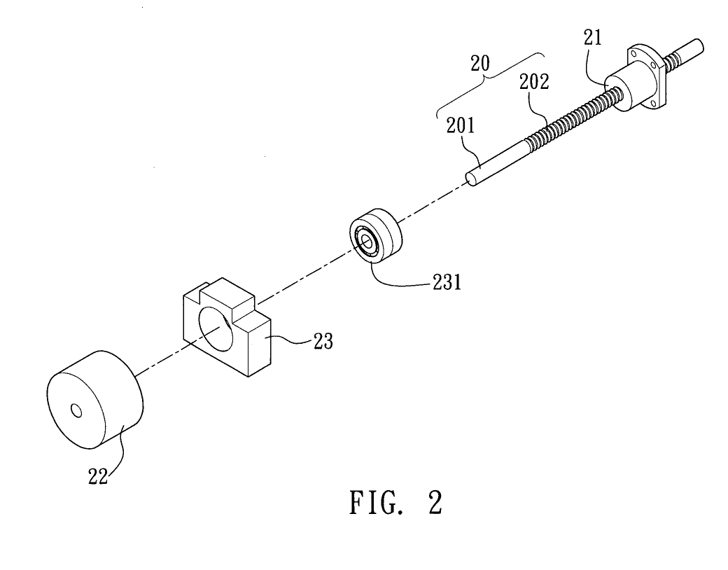

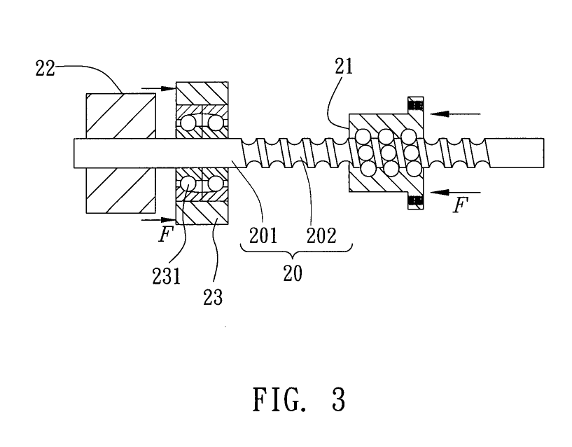

Referring to FIGS. 2 and 3, a screw type inerter mechanism according to the present invention is disclosed. The screw type inerter mechanism includes a screw 20, which has a limit portion 201 and a thread portion 202 with threads; a nut 21 engaged with the thread portion 202 of the screw 20; an inertia body 22 fixed on the limit portion 201 of the screw 20, wherein the axis of the screw 20 is the rotation axis of the inertia body 22; and a connection body 23 comprising bearings 231, wherein the connection body 23 is engaged with a specific position of the limit portion 201 of the screw 20 through the bearings 231 such that when the screw 20 rotates relatively to the connection body 23, the horizontal and vertical positions of the connection body 23 relative to the screw 20 do not change.

In the above structure, the engagement portions between the nut 21 and the screw 20 are a ball screw set so as to greatly reduce friction force and eliminate backlash by preloading. Since techniques related to the ball screw are quite various and well known in the art and not characteristic of the present invention, detailed description thereof is omitted.

As shown in FIG. 3, if two forces F are applied to the connection body 23 and the nut 21 in opposite directions parallel to the axis of the screw 20 so as to allow the connection body 23 to have horizontal displacement relative to the nut 21 and in parallel with the axis of the screw 20, the screw 20 is brought to rotate around its axis due to interaction between the bearings and threads. Further, the inertia body 22 is fixed to the limit portion 201 of the screw 20, and the axis of the screw 20 serves as the rotation axis of the inertia body 22. When the screw 20 rotates around its axis, the inertia body 22 is brought to rotate. In addition, when the screw 20 rotates, the connection body 23 will not rotate due to action of the bearings 231, and horizontal and vertical positions of the connection body 23 relative to the screw 20 do not change.

The horizontal displacement of the connection body 23 relative to the nut 21 is in parallel with the axis of the screw 20, and can be in a positive direction or in a negative direction, which brings the screw 20 to rotate clockwisely or counterclockwisely. The directions of the horizontal displacement and the screw rotation can be determined according to design of the thread. The relationship between the horizontal displacement of the connection body 23 and the nut 21 and angular displacement of the screw can also be determined according to design of the thread.

Now the relative horizontal displacement of the connection body 23 and the nut 21 is analyzed according to the inerter theory. The nut 21 and the connection body 23 can be considered as two terminals of the inerter. If the relative horizontal displacement between the nut 21 and the connection body 23 along the axis of the screw is x which is caused by a resultant external force F, then the following equation can be derived from Newton's Second Law:

$$F = I \cdot {( \frac{2 π}{P} )}^{2} \cdot \ddot{x} = b \cdot a ,$$

wherein a is the relative acceleration of the two terminals, I the total mass moments of inertia of the inertia body and the screw, P the screw pitch, and b is the inertance. According to the equation, a suitable screw type inerter mechanism can be designed by adjusting the screw pitch or the inertia of the rotation bodies. Further, since the horizontal displacement x is a relative motion between the two terminals, the acceleration a is also a relative acceleration between the two terminals. Thus, the following equation is obtained:

F=b·(a₂−a₁),

wherein a₁ and a₂ are absolute accelerations of two terminals. The equation shows that the present mechanism becomes a two-terminal mechanical structure, and has the inerter properties that is not limited by the prior art wherein acceleration of the mass must be measured relative to the ground. Therefore, the mechanical structures can ideally correspond to electrical elements.

### Second Embodiment

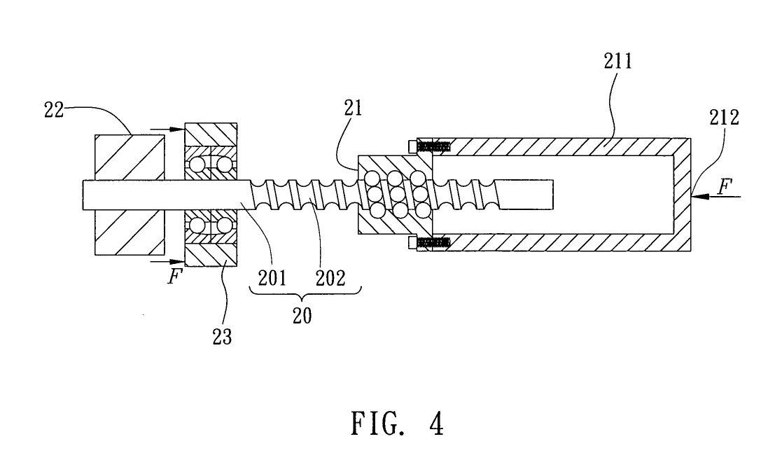

As shown in FIG. 4, a screw type inerter mechanism is disclosed according to the second embodiment of the present invention. Compared with the first embodiment, the inerter mechanism of the present embodiment further includes an assisting element 211 such as a sleeve connected to the nut 21, wherein the assisting element 211 has a connection point 212 through which an external machine can be connected to the present mechanism. An external force F can be applied to the present mechanism through the assisting element 211 so as to allow the nut 21 to move in parallel with the screw 20, thereby increasing the freedom of connection design and protecting the nut 21 from being damaged by force directly applied thereon.

### Third Embodiment

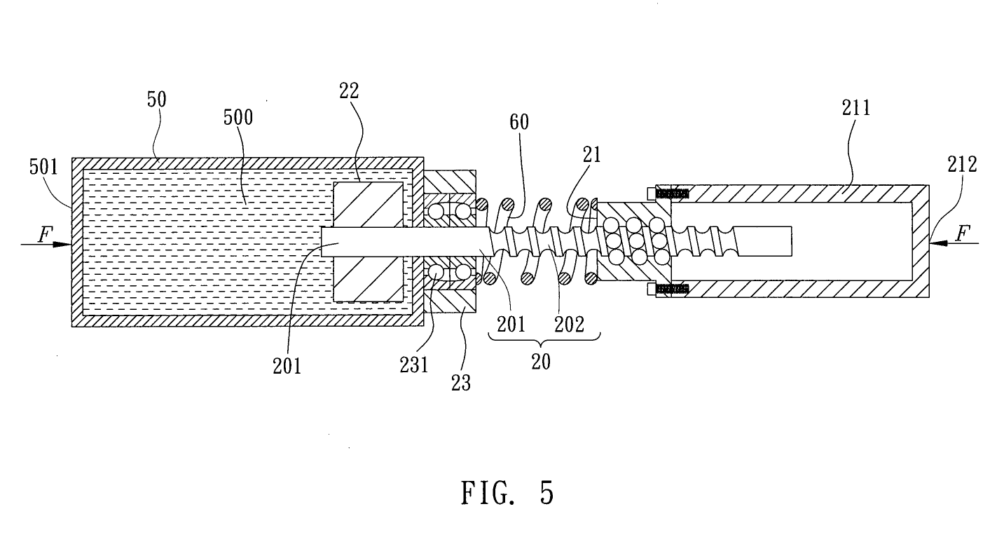

FIG. 5 is diagram of a screw type inerter mechanism according to the third embodiment of the present invention. In this embodiment, the connection body 23 is connected to an assisting element 50 such as a sleeve, wherein the assisting element 50 encapsulates the inertia body 22, viscous oil 500 is injected into the assisting element 50, and the assisting element 50 is disposed with a connection point 501 for connecting an external machine. Also, an elastic element 60 such as a spring is disposed between the nut 21 and the connection body 23 so as to obtain a mechanical oscillation system including an elastic element, a fluid damper and a screw type inerter mechanism.

Referring to the motion analysis of the first embodiment, the present embodiment is analyzed using the inerter theory. When an external force F is applied to the oscillation system to generate relative horizontal displacement between the nut 21 and the connection body 23, the screw 20 is brought to rotate around its axis due to interaction between the bearings and threads, which further brings the inertia body 22 to rotate. At this time, a viscous friction force is generated between the inertia body 22 and the fluid viscous damper 500, thus achieving a damping effect. Further, since the screw cap 21 has a displacement relative to the connection body 23, the elastic element 60 connected between the nut 21 and the connection body 23 can store energy.

In the above-described structure, the engagement portions of the nut 21 and the screw 20 are a ball screw set so as to greatly reduce friction forces and eliminate backlash by preloading, thereby making the present mechanism close to an ideal inerter body.

In addition, inertance of the inerter mechanism of the present invention can be changed by adjusting the mass moments of inertia of the inertia body according to the following equation:

$$I = \frac{1}{2} {\sum }_{i = 1}^{N} {m}_{i} {r}_{i}^{2} ,$$

in which the inertia I of an inertia body with multiple mass points is the sum of mass (mᵢ) of each mass point multiplied by the square of distance (rᵢ) of each mass point to the rotational axis. Therefore, if the mass or rotation radius of each mass point is changed, the inertia of the inertia body can be changed, which further changes the inertance of the present inerter mechanism. In the following three embodiments, mass or distance of each mass point to the rotational axis is changed so as to change rotation inertia of the inertia body.

### Fourth Embodiment

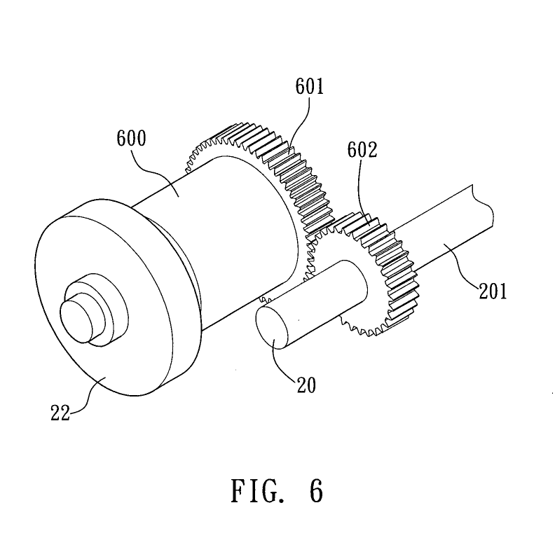

Referring to FIG. 6, the present embodiment is similar to the first embodiment, and the only difference of the present embodiment from the first embodiment is the connection relationship between the screw 20 and the inertia body 22.

As shown in FIG. 6, the inertia body 22 is fixed to a gear box 600, which has a gear set (not shown) disposed therein. One end of the gear set is connected to the inertia body 22, and the other end of the change gear set is connected to a transmission gear 601. A driving gear 602 is fixed on the limit portion 201 of the screw 20, and the transmission gear 601 is engaged with the driving gear 602 so as to form mechanical connection between the screw 20 and the inertia body 22. When the screw 20 rotates, the driving gear 602 is brought to rotate. At this time, the driving gear 602 brings the transmission gear 601 to rotate synchronously, which further brings the inertia body 22 to rotate through the speed change gear set of the gear box 600.

As disclosed by the first embodiment, since the inertance of the system is calculated according to the following equation:

b=I·(2π/P)²

wherein b represents the inertance, I is the sum of inertia of the rotation bodies, and P is the pitch of the screw. The rotation body includes the screw 20 and the inertia body 22. In the present embodiment, by adjusting gear ratio α of the speed change gear set, the influence of the rotation inertia of the inertia body 22 to the inertance of the system is adjusted as I·(2πα/P)², and meanwhile the inertance of the system is also influenced by the inertia of the gear set, the transmission gear 601 and the driving gear 602.

Therefore, by disposing the gear box 600 to adjust the gear ratio, the inertia can be changed, and accordingly the inertance of the screw type inerter mechanism can be easily adjusted.

### Fifth Embodiment

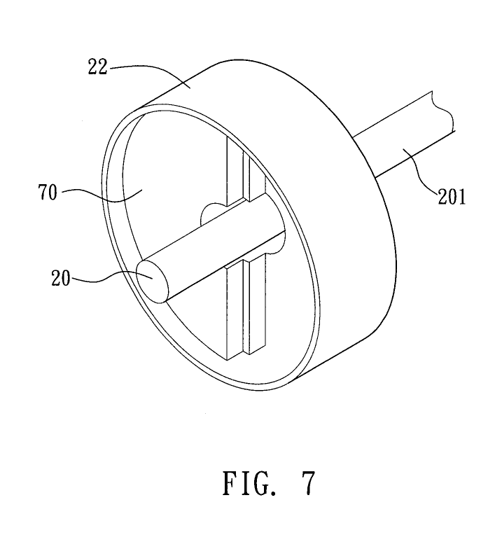

Referring to FIG. 7, the present embodiment is similar to the first embodiment, and the only difference of the present embodiment from the first embodiment is that the structure of the inertia body 22 is changed.

As shown in FIG. 7, the inertia body 22 includes at least one mass block 70 disposed inside thereof so as to increase mass of the inertia body 22. The inertia body 22 is fixed to the limit portion 201 of the screw 20. When the screw 20 rotates, the inertia body 22 is also brought to rotate.

According to the equation b=I·(2π/P)², wherein b represents the inerter coefficient of the inerter theory and I is the sum of inertia of the rotation bodies (including the screw 20 and the inertia body 22), the inertance is affected by the inertia of the screw 20 and the inertia body 22, and is determined by masses and rotation radius of the elements.

Therefore, by additionally disposing at least one mass block 70, the rotation inertia can be changed, and accordingly the inerter coefficient of the screw type inerter mechanism can be adjusted.

### Sixth Embodiment

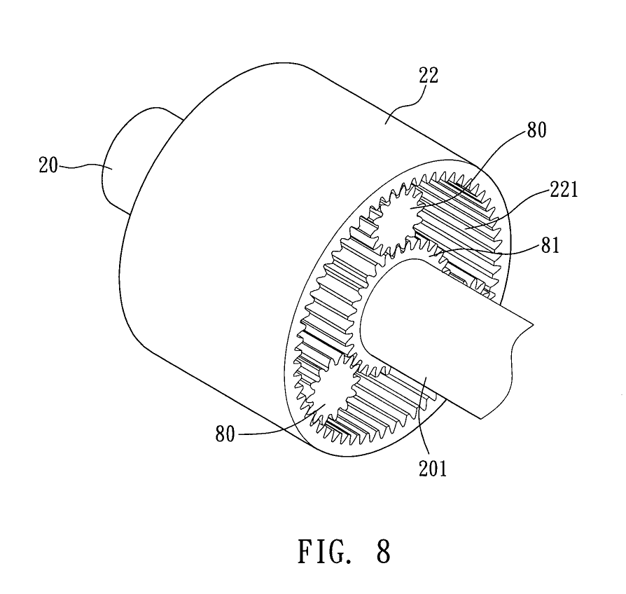

Referring to FIG. 8, the present embodiment is similar to the first embodiment, and the only difference of the present embodiment from the first embodiment is the connection relationship between the screw 20 and the inertia body 22.

As shown in FIG. 8, the inertia body 22 is sleeve type and includes an inner gear 221. The inner gear is engaged with at least a planetary gear 80, and a sun gear 81 is fixed to the limit portion 201 of the screw 20 and engaged with the planetary gear 80 so as to establish mechanical connection between the screw 20 and the inertia body 22. When the screw 20 rotates, the sun gear 81 is brought to rotate. At this time, the sun gear 81 brings the planetary gear 80 to rotate, which further brings the inner gear 221 of the inertia body 22 to rotate, thereby making the inertia body 22 rotate.

According to the equation b=I·(2π/P)², wherein b represents the inerter coefficient of the inerter theory and I is the sum of rotation inertia of the rotation bodies (including the screw 20, the inertia body 22, the sun gear 81 and the planetary gear 80), the inertance is affected by the inertia of the inertia body 22, the sun gear 81 and the planetary gear 80. Besides, the inertia is determined by masses and rotation radius of the elements.

Therefore, the inertia I can be changed by changing the inner structure of the inertia body 22. That is, by changing the gear ratio of the sun gear 81 and the planetary gear 80, the radius of each mass point of the planetary gears, the inertance of the screw type inerter mechanism can be adjusted.

Therefore, a mechanical oscillation system can correspond to a circuit oscillation system, in which the elastic element 60, the viscous damper 500 and the present inerter mechanism correspond to an inductor, a resistor and a capacitor, respectively, of the circuit system by the force-current analogy. Further, referring to the first embodiment, the inerter mechanism is a two-terminal mechanical structure and is not limited as in the prior art that acceleration of the mass must be measured relative to the ground. Therefore, mechanical structures can ideally correspond to electrical circuits.

Thus, according to the screw type inerter mechanism of the present invention, if a non-zero external force is applied to the system of the present invention so as to generate relative horizontal displacement between the nut and the connection body, the screw rotates and further causes the inertia body to rotate, thereby achieving inerter features. Furthermore, since backlash between the nut and the screw is not so serious as in the prior art, and can be eliminated by preloading, a ball-screw set can be used to greatly reduce friction force. Thus, the mechanism of the present invention is much closer to an ideal inerter, thereby improving the corresponding relationship between electrical circuits and mechanical networks.

The above-described descriptions of the detailed embodiments are only to illustrate the preferred implementation according to the present invention, and it is not to limit the scope of the present invention, Accordingly, all modifications and variations completed by those with ordinary skill in the art should fall within the scope of present invention defined by the appended claims.

What is claimed is:

1. A screw type inerter mechanism, comprising:
a screw having a limit portion and a thread portion with threads;
a nut engaged with the thread portion of the screw;
an inertia body fixed on the limit portion of the screw; and
a connection body engaged with the limit portion of the screw, wherein an axial of the screw serves as a rotation axial for the screw to rotate relatively to the connection body.

2. The screw type inerter mechanism of claim 1, wherein the connection body comprises bearings.

3. The screw type inerter mechanism of claim 2, wherein the connection body is engaged with a specific position of the limit portion of the screw through the bearings, and the screw rotates relatively to the connection body without changing relative horizontal and vertical positions of the connection body and the screw.

4. The screw type inerter mechanism of claim 1, wherein the screw and the nut are a ball screw set, and backlash between the screw and the screw cap is eliminated by preloading.

5. The screw type inerter mechanism of claim 1, wherein the inertia body is adjustable.

6. The screw type inerter mechanism of claim 5, wherein the inertia body comprises a plurality of mass blocks, each of the mass blocks rotates around the axis of the screw, and mass and rotation radius of each of the mass blocks are adjustable.

7. The screw type inerter mechanism of claim 5, wherein the inertia body is fixed in a gear box having gear sets disposed therein.

8. The screw type inerter mechanism of claim 5, wherein the inertia body is a sleeve type flywheel set comprising an inner gear, a sun gear and a planetary gear.

9. The screw type inerter mechanism of claim 1, wherein the inertia body is a flywheel.

10. The screw type inerter mechanism of claim 1, further comprising an assisting element connected to the nut, and having at least a connection point to connect an external machine.

11. The screw type inerter mechanism of claim 1, further comprising an assisting element connected to the connection body, and having at least a connection point to connect an external machine.

12. The screw type inerter mechanism of claim 11, wherein the connection body is injected with a fluid viscous damper.

13. The screw type inerter mechanism of claim 1, further comprising an elastic element disposed between the nut and the connection body.

14. The screw type inerter mechanism of claim 13, wherein the elastic element is a spring.
